(19) United States
(12) Patent Application Publication
(10) Pub. No.: US 2008/0091465 A1
(43) Pub. Date: Apr. 17, 2008

(54) Customizable System for Monitoring Record Completion for Healthcare and Other Uses

(75) Inventors: Stephen D. Fuschino, Pottstown, PA (US); Vincent Guaglione, Morrisville, NC (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., MALVERN, PA (US)

(21) Appl. No.: 11/869,918

(22) Filed: Oct. 10, 2007

Related U.S. Application Data
(60) Provisional application No. 60/829,698, filed on Oct. 17, 2006.

(51) Int. Cl. G06Q 50/00

(52) U.S. Cl. 705/2

(57) ABSTRACT

A system enables interested software applications, AKA subscribers, which are loosely coupled to a HIM (Healthcare Information Management) system, to receive interface transactions/notifications when one or more specific documents types are present in a patient's encounter folder. The system enables a named group of minimum content rules to be defined, assigned and adapted to the needs of a specific subscriber. Software applications of Interest include Coding Management systems, Clinical applications, workflow software or any other system that that can benefit from triggering workflow based on specific types of electronic documents being present in a patients encounter folder.

This is a non-provisional application of provisional application Ser. No. 60/829,698 filed Oct. 17, 2006, by S. D. Fuschino et al.

### FIELD OF THE INVENTION

This invention concerns a healthcare record processing system for managing encounter record completion including initiating a sequence of tasks and determining when a particular patient record of an encounter having a particular type meets associated completion criteria in response to a predetermined event.

### BACKGROUND OF THE INVENTION

Healthcare Information Management (HIM) departments are responsible for ensuring that a patient medical record is “complete” and accurate. In other words they make sure that no documents are missing from the patient record and that the documents that are present are complete, accurate and signed if they need to be signed. HIM departments follow guidelines dictated by accreditation organizations such as JCAHO (Join Commission on Accreditation of Healthcare Organizations) to ensure that patient records are complete. One of the guidelines dictates that certain documents need to be present in a patient record before releasing the record for medical coding (i.e., allocating of ICD9 and other diagnostic codes, for example). The type of documents that need to be present may vary based on certain characteristics of a Patient encounter, e.g., a Discharge Summary document needs to be present in a patient record before the record can be coded. A patient encounter comprises a patient interaction with a healthcare provider organization such as a visit, phone call or hospital stay.

In known systems, users can require that a folder contain a specific set of documents before releasing the record. But if the folder needs to be released to more then one workflow process based on differing document contents, there is typically no way to automatically accomplish this task. In known systems a folder needs to be manually released by a user. Further, in known systems, HIM personnel need to manually verify that documents required to exist in a patient record are present before releasing the record for further processing and once verified. HIM personnel need to perform manual steps in order to release the record for further processing. An adaptive system according to invention principles addresses these deficiencies and related problems.

### SUMMARY OF THE INVENTION

Known systems that allow HIM departments to require that a document be present in a patient record before releasing the record for medical coding typically do not automatically release the record to multiple workflow processes based on folder attributes and determines a minimum required set of documents is present in the folder. A medical coding application is used in assigning medical codes (such as an ICD9 diagnosis code) to a text clinical diagnosis for use in medical reimbursement billing, for example. A system enables interested (i.e., subscribing) software applications associated with a HIM (Healthcare Information Management) system, to receive interface transactions and notifications when one or more specific documents types are present in a patient encounter folder and enables a named group of minimum content rules to be defined, assigned and adapted to the needs of a specific subscriber. A healthcare record processing system for managing encounter record completion includes a configuration processor enabling association of configurable record completion criteria with a type of encounter of a patient with a healthcare provider organization. The record completion criteria are configurable by an executable application and indicate document content required in a record of a type of encounter, for the record to be designated complete. A data processor determines when a particular patient record of an encounter having a particular type meets associated completion criteria in response to a predetermined event. A workflow processor automatically initiates a sequence of tasks to be performed by at least one healthcare worker in response to a determination the particular patient record of the encounter having the particular type meets the associated completion criteria.

### BRIEF DESCRIPTION OF THE DRAWING

FIG. 1 shows a healthcare record processing system for managing encounter record completion, according to invention principles.

FIG. 2 shows an operational architecture of a healthcare record processing system for managing encounter record completion, according to invention principles.

FIG. 3 shows a User Interface display image for use in establishing rules to use in determining a record is complete, according to invention principles.

FIG. 4 shows a User Interface display image for assigning a record completion rule to a group, according to invention principles.

FIG. 5 shows a User Interface display image for configuring completion processing of records using completion rules, according to invention principles.

FIG. 6 shows a flowchart illustrating record completion processing, according to invention principles.

FIG. 7 shows a User Interface display image indicating record completion status, according to invention principles.

FIG. 8 shows a flowchart of a process used in a healthcare record processing system for managing encounter record completion, according to invention principles.

### DETAILED DESCRIPTION OF THE INVENTION

A system enables interested software applications (subscribing applications), which are loosely coupled to a HIM (Healthcare Information Management) system, to receive interface transaction and notification messages when one or more specific document types are present in a patient encounter folder. An encounter is an interaction of a patient with a healthcare provider organization including an inpatient or outpatient visit, hospital stay or phone call. The system enables a named group of minimum content rules to be defined, assigned and adaptively altered to meet the needs of a specific subscribing application. The minimum content rules determine the minimum content of a folder necessary for a folder to be designated complete. Software applications of Interest include Coding Management systems, Clinical applications, workflow software or another system that that can benefit from triggering workflow based on specific types of electronic documents being present in a patient encounter folder. An adaptive system according to invention principles enables a user to create and configure a set of criteria that a folder (e.g., one or more files or documents) needs to meet in order for the folder to be released for processing by a workflow. A workflow comprises a sequence of tasks for performance by a worker or device or both, in processing a document, for example, such as a medical coding workflow.

The system provides users of a HIM system with a way to comply with JCAHO regulations. A user may also configure the system to adaptively employ different minimum content rules based on attributes of a Patient Encounter Folder such as Encounter Type, Financial Class or Hospital Service. Thereby, a user of a HIM may require that a specific set of documents be present in a patient record before automatically releasing it for medical coding processing and to any other workflow process requiring particular documents to be present within the folder. Characteristics of a document include such things as Document Type, Creation Date and Document Date. A document type provides a way to categorize a document. Examples of document types include a discharge summary, face sheet, correspondence, EKG strip, nursing assessment and dictation, for example. The term record completion refers to a condition achieved by an encounter record when one or more specific types of documents are present in the encounter record. The criteria for this condition can vary by application and encounter characteristics. The criteria for this condition is referred to as “minimum required folder contents” which is a list that is configurable, for example, in response to both the application processing encounter folder data and encounter characteristics, to specify types of documents that need to be present in the encounter folder.

The term complete refers to a condition achieved by a patient record or document when the information contained therein is verified to be accurate and whole. In the case of a document, this means when there is no missing information relevant to the document and contained information is true. In the case of a patient record, this means when expected/required documents exist for that patient record and documents contained in it are “complete”. An encounter folder refers to an electronic folder which contains images and text documents associated with a patient encounter. The term record is an equivalent term for “folder”. The two terms are used interchangeably. A subscribing application is an application that has registered interest in EDM (Electronic Data Management) events such as the insertion of documents and the modification of record information

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor may comprise a combination of, hardware, firmware, and/or software.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure.

A workflow processor, as used herein, processes data to determine tasks to add to a task list, remove from a task list or modifies tasks incorporated on, or for incorporation on, a task list. A task list is a list of tasks for performance by a worker or device or a combination of both. A workflow processor may or may not employ a workflow engine. A workflow engine, as used herein, is a processor executing in response to predetermined process definitions that implement processes responsive to events and event associated data. The workflow engine implements processes in sequence and/or concurrently, responsive to event associated data to determine tasks for performance by a device and or worker and for updating task lists of a device and a worker to include determined tasks. A process definition is definable by a user and comprises a sequence of process steps including one or more, of start, wait, decision and task allocation steps for performance by a device and or worker, for example. An event is an occurrence affecting operation of a process implemented using a process definition.

A Workflow Management System is a software system that manages processes. It includes a process definition function that allows users to define a process that should be followed, an Event Monitor, which captures events from a Healthcare Information System and communicates the results to the Workflow Management System. A processor in the Management System tracks which processes are running, for which patients, and what step needs to be executed next, according to a process definition. The Management System includes a procedure for notifying clinicians of a task to be performed, through their worklists (task lists) and a procedure for allocating and assigning tasks to specific users or specific teams. A document or record comprises a compilation of data in electronic form and is the equivalent of a paper document and may comprise a single, self-contained unit of information.

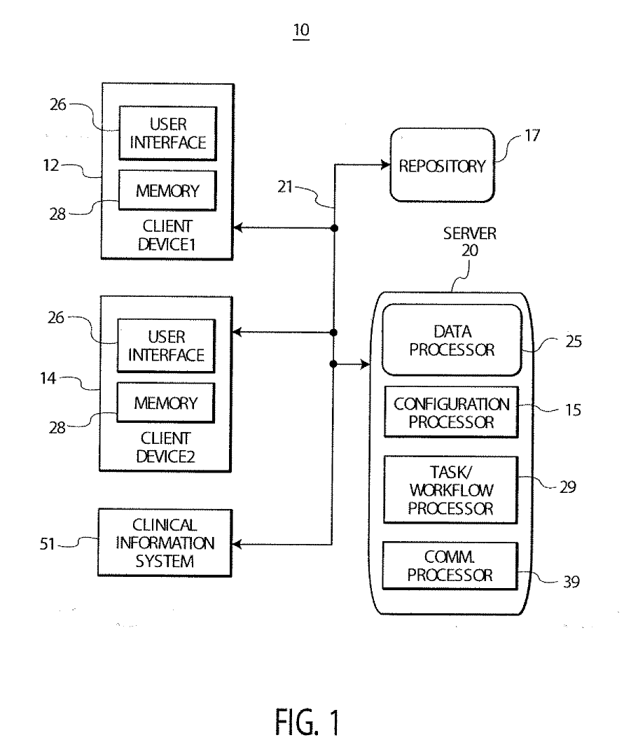

FIG. 1 shows a healthcare record processing system 10 for managing encounter record completion and including client devices (workstations) 12 and 14, repository 17, clinical information 51 and server 20 bidirectionally communicating via network 21. Configuration processor 15 executing on server 20 enables association of configurable record completion criteria with a type of encounter of a patient and with a healthcare provider organization. The record completion criteria are configurable by an executable application and indicate document content required in a record of a type of encounter, for the record to be designated complete. Data processor 25 determines when a particular patient record of an encounter having a particular type meets associated completion criteria in response to a predetermined event. Communication processor 39 automatically communicates a notification message to a subscribing application. The notification message indicates to the subscribing application that the particular patient record of the encounter is available for processing. Task processor 29 includes a workflow processor and automatically initiates a sequence of tasks to be performed by at least one healthcare worker in response to a determination the particular patient record of the encounter having the particular type meets the associated completion criteria.

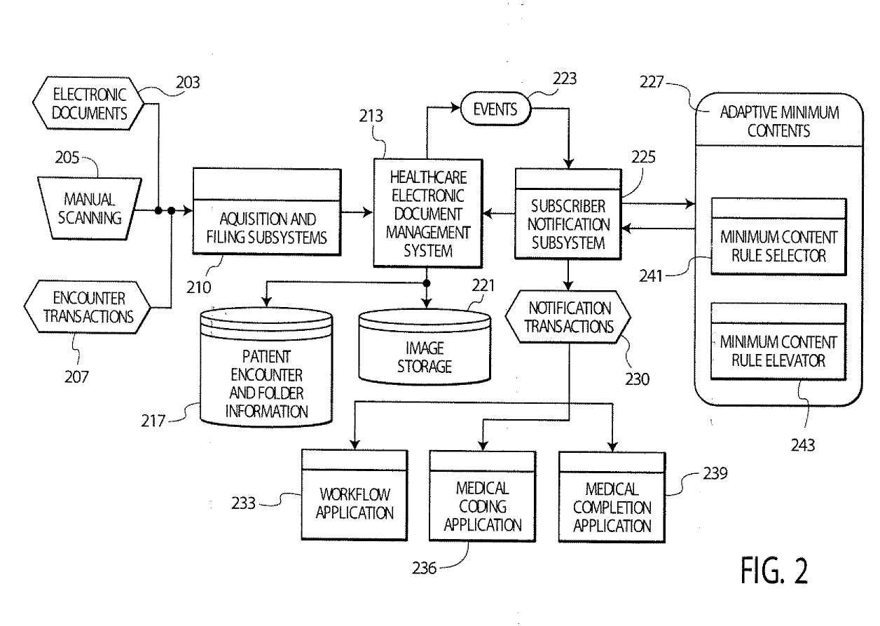

FIG. 2 shows an operational architecture of a healthcare record processing system for managing encounter record completion. Documents 203, encounter transaction messages 207 (including patient demographic information) and scanned documents 205 are acquired and processed by Acquisition Subsystem 210. Acquisition subsystem 210 processes acquired documents and transaction messages by applying filing and bursting rules and instructing HIM System 213 to store the transaction messages and documents. HIM System 213 updates patient encounter information in encounter and folder information 217 or files the documents in folder information 217 and document image storage system 221 depending on transaction characteristics. HIM System 213 generates a message including Encounter identification and other information and indicating occurrence of an event 223. System 213 communicates the message to interested subscribing applications 225 to indicate a type of action that occurred. Event types include “Update Encounter Folder”, “Create Encounter Folder” or “Insert a Document”, for example. Encounter information is passed with an event identifier. If a subscribing application is interested in the event identified in message 223 and system 10 (FIG. 1) determines from predetermined data that the event has a “Minimum Content Group” associated with it, operation of Adaptive Minimum Content subsystem 227 is initiated.

Adaptive Minimum Content subsystem 227 identifies a rule 241 that is used to determine if an Encounter folder is complete by matching rule criteria with the characteristics of the encounter. The identified rule is evaluated by evaluation unit 243 and one of the following results are passed to a subscribing application, (a) Minimum Content Met (single required document is present in folder), (b) All Minimum Content Met (all required documents are present in folder), and (c) Minimum Content Not Met. The subscribing application determines, in outbound transaction system 230 if a transaction notification message needs to be sent to external or internal applications in response to the result from the Adaptive Minimum Content subsystem 227. Upon the determination, unit 230 initiates generation of transaction notification messages and communicates the messages to workflow application 233, medical coding application 236 and medical completion application 239.

A subscribing application comprises an object or process that actively or passively listens for incoming messages. Incoming messages can originate from an external system and are normally received by a subscribing application in the form of a transaction message. System 225 enables a user to configure 1 to n subscribing applications, configure events for which each subscribing application wishes to receive transaction messages, and configure minimum content rules that are evaluated for subscribing applications. An outbound transaction message comprises transactions generated from a folder or document object that are to be provided from. HIM system 213 to any subscribing (or listening) application. Outbound transaction system 230 manages automated workflow processing between HIM system 213 and external systems. System 230 evaluates criteria configured for a subscribing application on each object that is processed when configured events occur within the system. When the object being processed meets conditions configured for a subscribing application, a transaction message for the object is generated and is communicated to the subscribing application.

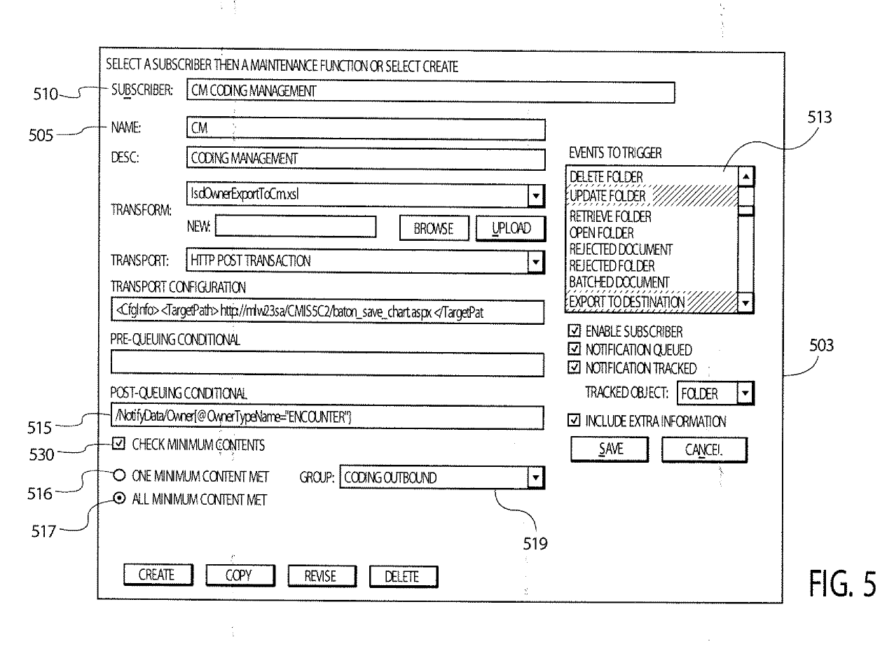

As mentioned previously, system 230 may be configured to automatically manage a workflow between HIM system 213 and one or more external systems (e.g., systems 233, 236). As an example, HIM users may require that a specific set of documents be present in a patient record (or Encounter folder) before automatically releasing the record to Coding Management application 236. Once released, the record appears in a user work queue in Coding Management application 236 without any manual intervention and is ready for medical coding. FIG. 5 shows User Interface display image 503 for configuring completion processing of records using completion rules. Specifically, display image 503 shows how subscribing application 510 (CM Coding Management) is configured to automate a workflow between HIM system 213 and a subscribing application. Display image 503 shows the properties of configured subscribing application 510 that is named CM 505. Specifically, display image 503 indicates HIM application events 513 are configured for subscribing application 510. HIM application events 513 are selected to trigger application of minimum content rules to determine an Encounter folder is complete. In particular, display image 503 illustrates application events comprising an “Update Folder” event and an “Export To Destination” event are selected to trigger application of minimum content rules.

Display image 503 enables use of conditional filtering logic 515 for identifying which Encounter types trigger use of minimum content rules, generate notification messages and initiate workflows. Display image 503 enables minimum content checking rules to be configured for subscribing application 510. The minimum content checking rules (rules of rule group 519), all need to be met as selected by a user via icon 517. The configuration of display image 503 in a HIM system indicates that when an “Update Folder” event or an “Export To Destination” event is generated within the system, an Encounter folder that is being processed is evaluated to ensure that it is an encounter level folder (515) and that this folder meets all minimum content requirements 517 specified by the rules that are assigned in the “Coding Outbound” minimum content group 519 in order to be released to a workflow process (a Coding Management application in the HIM).

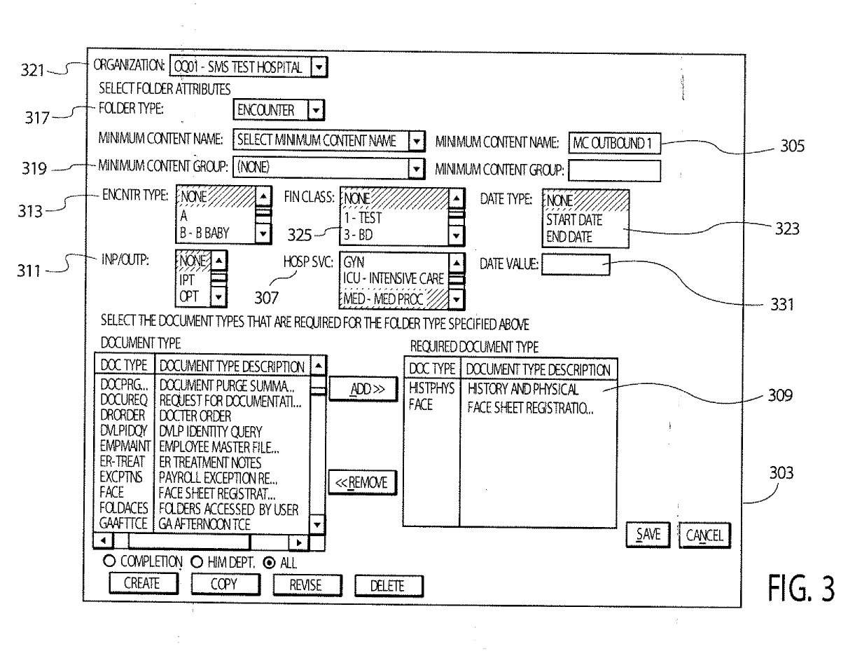

FIG. 3 shows User Interface display image 303 for use in establishing rules to use in determining a record is complete. A minimum content rule is a set of criteria that is used to evaluate a patient Encounter folder, for example, to determine if the folder is eligible to be released to one or more workflow processes. In HIM system 213 (FIG. 2), Encounter folder attributes Encounter Type, Inpatient/Outpatient Indicator, Financial Class, Hospital Service, and Encounter Start Date (or Encounter End Date) comprise part of the criteria available for use in a minimum content rule. The other part of the criteria comprises the set of documents, specified by Document Type, that are required to be contained in the Encounter folder. One or more groups of minimum content rules are specified by an organization associated with a HIM system.

User Interface display image 303 illustrates a minimum content rule being created called “MC Outbound 1” 305. The created rule specifies that a folder having a selected type, specifically Encounter type 317 with an attribute Hospital Service 307 selected and valued to “MED”, requires two Document Types to be present to be designated complete. The two Document Types 309 are selected to comprise, a “History and Physical” and a “Face Sheet”. An Encounter folder evaluated by HIM system 213 for minimum required content needed to satisfy the conditions of the rule in order to be designated complete and ready for further processing by a workflow process. Display image 303 also enables a user to select 321 an Organization associated with a created rule, a group 319 to contain a created rule, a financial class 325 of the created rule and a date 331 comprising a start or end date 323 of the rule.

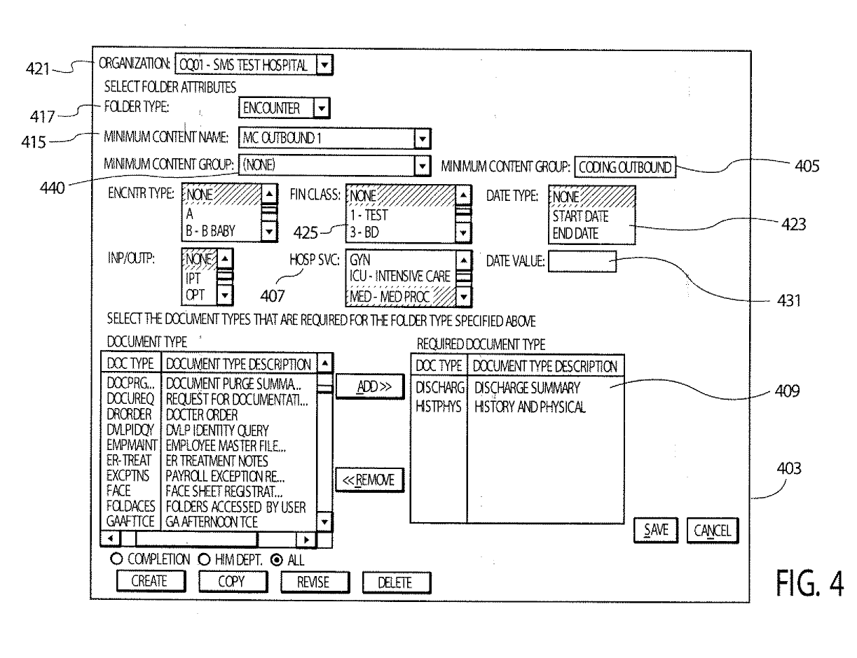

A minimum content group is a container indicating a set of related minimum content rules. Rules that are contained in a particular minimum content group are evaluated when that particular group is specified as the rule group a HIM system evaluates for a specific workflow process. Minimum content rules that are configured but are not part of a group being evaluated for the specific process are not evaluated by the system. In a HIM system, 0 to ‘n’ number of minimum content rule groups may be associated with an organization but in one embodiment, one minimum content rule group is assigned to be evaluated for any single workflow process. FIG. 4 shows User Interface display image 403 for assigning a record completion rule to a group. Display image 403 is the same as the FIG. 3 display image 303 except that display image 403 illustrates creation and assigning a minimum content rule groups for a set of minimum content rules used in a HIM application. User Interface display image 403 illustrates a minimum content rule called “MC Outbound 1” 415 being assigned to a minimum content rule group called “Coding Outbound” 405. Since this minimum content group did not previously exist, it is typed in by the user as a new group in the item 405 data field. If the group had previously existed but was not currently associated with minimum content rule 415, the group would have been available as a selection in the minimum content group dropdown list box 440. The created rule specifies a folder having a selected type Encounter 417 and an attribute Hospital Service 407 selected and valued to “MED” and requires two Document Types to be present to be designated complete. The two Document Types 409 are selected to comprise, a “History and Physical” and a “Discharge Summary”. An Encounter folder evaluated by HIM system 213 (FIG. 2) for minimum required content needs to satisfy the conditions of the rule in order to be designated complete and ready for further processing by a workflow process. Display image 403 also enables a user to select 421 an Organization associated with a created rule, a group 405 to contain a created rule, a financial class 425 of the created rule and a date 431 comprising a start or end date 423 of the rule.

System 10 (FIG. 1) is configurable to notify a subscribing application when either all specified document types are present in an Encounter folder or when one of the specified document types is present in the Encounter folder. Data processor 25 employs a process to match a patient encounter and Encounter folder to an appropriate minimum content rule. This process ensures that a patient encounter record is first evaluated using a minimum content rule with the most specific matching criteria. If the encounter record does not meet the specific criteria for the minimum content rule, data processor 25 looks to rules with more general criteria. This allows rules to be specified for special cases and allows use of broader criteria for more common rules. Each Minimum Content Rule has a number of criteria associated with it which are used to match an encounter record to a rule. The rules with the highest number of criteria are evaluated first. Once an encounter record qualifies to be evaluated against a Minimum Content rule it is not evaluated against any other Minimum Content rule.

System 10 creates and uses minimum content rules to manage workflow processing for an organization. Creation of the rules is illustrated in FIG. 3. In response to Encounter folder attributes and required document types being configured for a minimum content rule, the rule is associated with a minimum content group. FIG. 4 illustrates creation of a minimum content rule group. Multiple minimum content rules may be created and assigned to the same minimum content rule group if desired. This adds flexibility to a HIM system and enables determination of a condition requiring presence and/or particular characteristics of a combination of documents (within a set of documents) to trigger release of an Encounter folder or particular record in the folder, for processing by a medical coding application, for example. In response to configuration of minimum content rules and groups, a minimum content rule group is selected as a minimum content group to be used by a subscribing application as depicted in FIG. 5. The subscribing application is employed in a workflow involving Encounter folder documents that are released in response to processing of the Encounter folder using the minimum content rule group. In configuring a subscribing application, the “Check Minimum Contents” checkbox 530 of display image 503 is selected to activate minimum content checking procedures. Additionally, a user selects “One Minimum Content Met” 516 or “All Minimum Content Met” 517 properties of a subscribing application. These options instruct data processor 25 (FIG. 1) and HIM system 213 (FIG. 2) to evaluate all Encounter folder to determine if any one of the documents that are required to be contained in the Encounter folder currently exist in the folder or if all of the documents that are required to be contained in the Encounter folder currently exist in the folder, for example.

In response to occurrence of an event within a HIM system (e.g., within Clinical information System 51 FIG. 1) that a subscribing application is listening for (i.e., continually or intermittently attempting to detect by polling or acquiring transaction event related transaction messages), data processor 25 parses and evaluates the contents of an Encounter folder being processed. If the folder successfully passes each evaluation check required by a subscribing application, a transaction message is generated for this folder and data processor 25 initiates communication of the transaction message to a subscribing application.

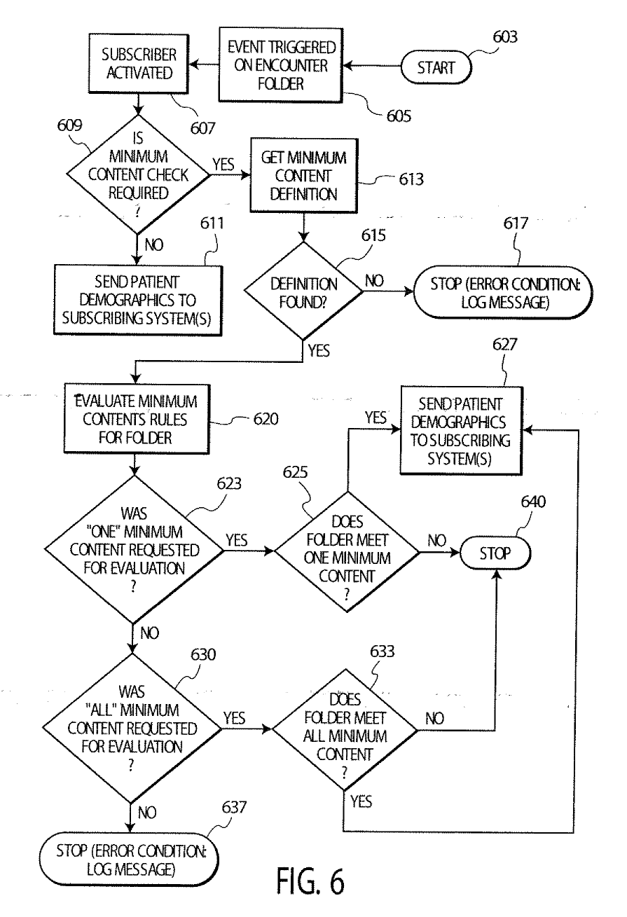

FIG. 6 shows a flowchart illustrating record completion processing, performed by outbound notification subsystem 230 of FIG. 2 (in data processor 25 of FIG. 1). In response to detection of occurrence of an event associated with a patient Encounter folder in step 605, following the start at step 603, a subscribing application listening for the detected event is activated in step 607. If in step 609 it is determined from pre-configured characteristics of the subscribing application that a minimum content check is not required on the Encounter folder, patient demographic information (including patient identifier, age weight, height, gender) is communicated to associated subscribing applications in step 611. If in step 609 it is determined from pre-configured characteristics of the subscribing application that a minimum content check is required, the minimum content rule definition is retrieved from repository 17 (FIG. 1) in step 613. If the minimum content rule definition cannot be acquired as determined in step 615, an error message is generated and logged with time and date in step 617. In response to successful acquisition of the minimum content rule definition as determined in step 615, the minimum content rules are applied to the Encounter folder of the patient in step 620.

In step 630 it is determined whether the minimum content rules indicate all minimum content documents are required in the Encounter folder, following a determination in step 623 that the rules cannot be satisfied by a single minimum content document being present in the Encounter folder. If it is indicated in step 630 that all minimum content documents are not required in the Encounter folder, the process of FIG. 6 stops at step 637 and an error message is generated and logged with associated time and date. Otherwise following step 630, it is determined in step 633 whether the Encounter folder contains all minimum content documents and if it does, patient demographic information is communicated to associated subscribing applications in step 627. If the Encounter folder does not contains all minimum content documents, the process of FIG. 6 terminates in step 640. Further, in step 623 if it is indicated the rules may be satisfied by a single minimum content document being present in the Encounter folder, the Encounter folder is examined for the single minimum content document in step 625. If in step 625 it is determined that the single minimum content document (e.g., a particular document type such as a discharge summary) is not present, the process of FIG. 6 terminates in step 640. Otherwise if the Encounter folder contains the single minimum content document, patient demographic information is communicated to associated subscribing applications in step 627.

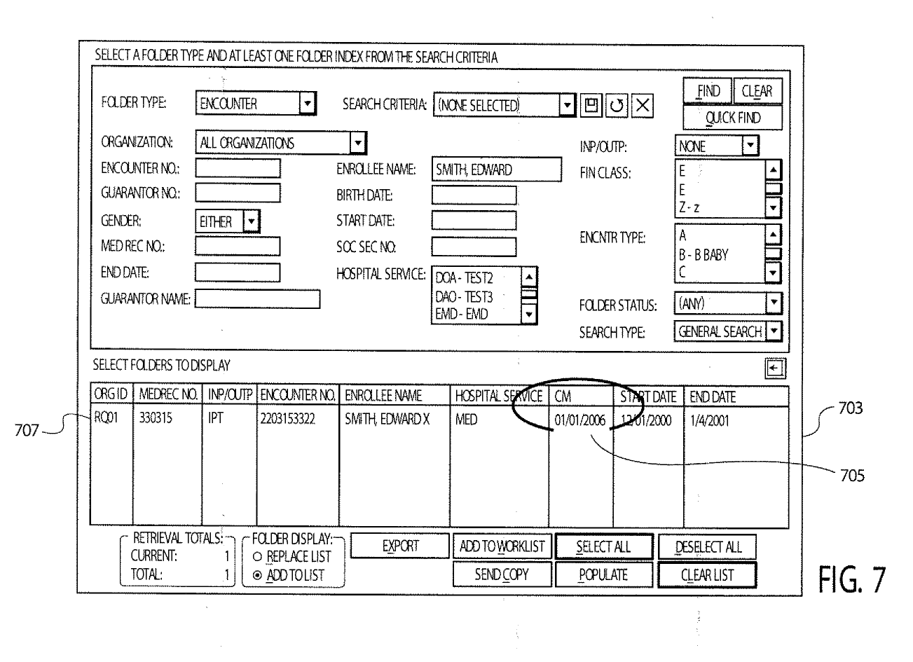

FIG. 7 shows User Interface display image 703 indicating record completion and workflow initiation status. The “CM” (Coding Management application) column on row 707 contains a date value of 01/01/2006 (item 705). This indicates that a release of the Encounter folder from the patient record of Edward X. Smith having patient identifier 330315 and an encounter identifier 2203153322 to the Coding Management system occurred on 01/01/2006. If this Encounter folder had not been released to the Coding Management application, the CM field would be empty. System 10 (FIG. 1) is able to advantageously automatically (without human intervention) initiate and adapt multiple concurrently operating workflows based on minimum content rules processing. Thereby a HIM system is provided with an ability to automatically comply with existing regulations without manual intervention. Further, in response to system 10 receiving confirmation that an Encounter folder has been accepted by an external system, an informational record is entered in a database table in repository 17 listing an identifier of the Encounter folder released as well as a name of the external system that accepted the folder, and the date and time of when the record was accepted by the external system. The “CM” column date value of 01/01/2006 (item 705) provides a visual confirmation indicating the Encounter folder was received and accepted by the external Coding Management application system.

System 10 enables definition of “Minimum Content” rules specific to a type of encounter (e.g., surgery, outpatient visit, laboratory test). System 10 employs criteria to associate and qualify a Patient Encounter folder for “Minimum Content” rule evaluation. The qualification criteria include Hospital Service (e.g., MRI, laboratory test), Patient Financial Class (fully or partially insured), Patient Encounter Type, Patient Encounter Start Date, Patient Encounter Stop Date and whether or not a Patient Encounter is an Inpatient or Outpatient visit. If a particular patient Encounter folder meets the qualification criteria, the minimum content rules are applied, otherwise they are not. This allows rules to be tailored to a particular type of patient encounter. The encounter Stop or Start date criteria allows rules to be defined that automatically take effect at some point in the future based on an Encounter Start or Stop date. This allows workflows that are migrating from a manual process to an automatic process to receive filtered transactions for appropriate Encounters. For example, migrating from a manual medical coding process to an automated medical coding process at a specific point in time involves definition of codes to use at a particular future date. Further, system 10 enables “Minimum Content” rules qualification criteria to be specified in general or specific terms. This allows a user to specify unique criteria for rules to handle special cases as well as more general criteria to handle more common “Minimum Content” requirements. The qualification process for a Minimum Content Rule Evaluation uses a rule that matches the most specific criteria before looking at more general rules. This allows specific rules to be defined for special cases and more general rules to qualify other cases. This minimizes the number of rules that need to be defined and maintained while providing flexibility to handle special cases. For example a general rule may be created for all Outpatient encounters and a more specific rule for emergency room encounters (hospital service=EMR, item 307 FIG. 3). Also system 10 initiates and adapts workflows in response to Minimum Content rules processing and groups “Minimum Content” rules in a named group in association with one or more interested subscribing applications. This enables rule qualification criteria and rules to be customized to specific application requirements. “Minimum Content Rules” can be grouped and the groups can be associated with specific workflows or subscribing applications. The evaluation of “Minimum Content Rules” is triggered by events such as updates to Patient Encounter folder attributes or the insertion of a document into a Patient Encounter Folder. This allows for the dynamic reevaluation of the “Minimum Content” qualification rules at the time an event is triggered.

System 10 generates interface transaction messages that include information related to a Patient encounter and medical record. This information also includes a pointer which is used to launch a HIM system application and display related documents. Minimum content rule evaluation is triggered by events occurring within a HIM system (or in a CIS). Further minimum content rules are reevaluated when information associated with a Patient Encounter folder is updated or a document is inserted into the Patient Encounter folder, for example. Rather than having to poll thousands of folders, system 10 initiates selected workflows in response to events and in response to evaluation of Minimum Content rules upon occurrence of relevant (previously associated) events. Such relevant events include, upon insertion of a document in an Encounter folder or the updating of information in a folder that might cause the encounter to be qualified for evaluation of a minimum content rule.

The interface used to notify a subscribing application is configurable and supports: HTTP Post, Network Copy, FTP Transfer, TCP/IP Transfer, Execution of an external process and an Internal Function call, for example. Notification messages may be sent to subscribing applications when minimum document contents are met as configured for the subscribing application. A subscribing application is configurable to be notified if any one of a predefined list of document types exist in an Encounter folder or when all of a predetermined list of document types are present in the folder. System 10 is configurable to prevent communication of messages conveying duplicate transaction information to minimize the volume of processing performed by subscribing applications. Further, system 10 keeps track, by encounter, of which subscribing applications have received a message identifying transactions and this tracking information is used to filter the sending of notification messages to subscribing applications. In an exemplary embodiment, system 10 interfaces with a Coding Management application and reduces the amount of time that a HIM department employs in coding a patient record because the record is automatically delivered to a work queue of a worker performing the coding once documents that are required to be present in the record exist in the record. System 10 advantageously automatically releases a record to a workflow process when documents are present in the record.

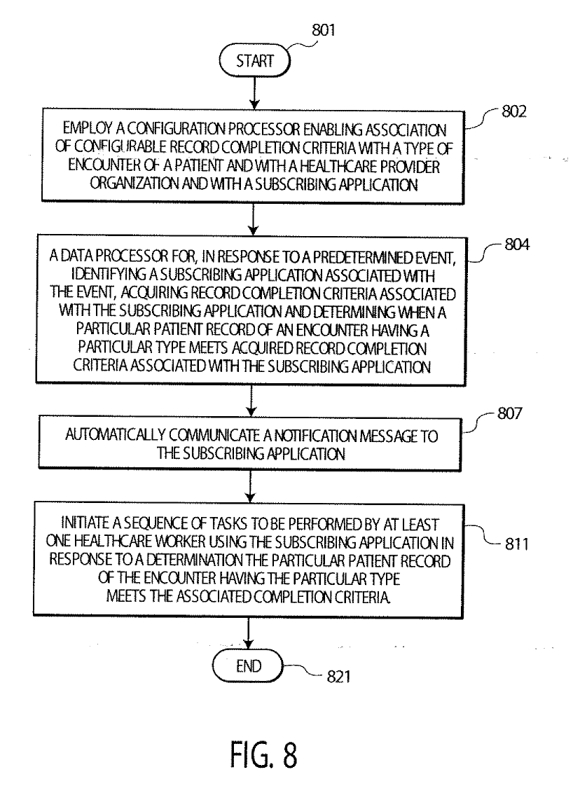

FIG. 8 shows a flowchart of a process used in healthcare record processing system 10 (FIG. 1) for managing encounter record completion. In step 802 following the start at step 801, configuration processor 15 enables association of configurable record completion criteria with a type of encounter of a patient and with a healthcare provider organization and with a subscribing application. The record completion criteria indicate minimum document content and other characteristics required of a record, document or folder (e.g., an Encounter folder) of a type of encounter, for the record to be designated complete and are automatically and dynamically configurable with criteria having a particular start date, a particular start time, a particular stop date and a particular stop time. The characteristics of the document include a Document Type comprising at least one of (a) discharge summary, (b) a face sheet, (c) correspondence, (d) EKG information, (e) a nursing assessment of a patient and (f) a dictated report, for example. The record completion criteria are configurable to be associated with at least one user (e.g., in response to user command or by a subscribing application), enabling the record completion criteria to be dynamically customized for the at least one user. The record completion criteria determines at least one of, (a) documents necessary in an encounter record of a particular type, (b) documents needing to be signed in an encounter record of a particular type and (c) information needed to be in a document in an encounter record of a particular type.

A type of encounter comprises, a patient visit to a hospital, an inpatient stay or an outpatient encounter. Further, in one embodiment, the record completion criteria are configurable by a subscribing application and indicate document content required in a record of a type of encounter, for the record to be designated complete. In step 804, data processor 25, in response to a predetermined event, identifies a subscribing application associated with the event, acquires record completion criteria associated with the subscribing application enabling the record completion criteria to be dynamically customized for a particular subscribing application and determines when a particular patient record of an encounter having a particular type meets acquired record completion criteria associated with the subscribing application. The record completion criteria are configurable to be associated with selected multiple subscribing applications, enabling the record completion criteria to be dynamically customized for particular multiple executable applications. The predetermined event comprises at least one of, (a) addition of a document to the particular patient record of the encounter, (b) signing of a document in the particular patient record of the encounter and (c) addition of information to a document in the particular patient record of the encounter.

In step 807, communication processor 39 automatically communicates a notification message to the subscribing application. The notification message indicates to the subscribing application that the particular patient record of the encounter is available for processing. Task processor 29 includes a workflow processor and in step 811 automatically initiates a sequence of tasks (a workflow) to be performed by at least one healthcare worker (and/or a device) using the subscribing application in response to a determination the particular patient record of the encounter having the particular type meets the associated completion criteria. The workflow processor in one embodiment, automatically initiates a plurality of concurrently operating workflows individually comprising a sequence of tasks to be performed by at least one healthcare worker or device. Further, task processor 29 releases the particular patient record of the encounter for processing by the subscribing application and inhibits release until the patient record of the encounter meets the associated completion criteria. In addition, data processor 25 re-evaluates whether a particular patient record of an encounter meets associated record completion criteria in response to a predetermined event and task processor 29 automatically communicates a notification message to the subscribing application in response to a re-evaluation. The process of FIG. 8 terminates at step 821.

The systems and processes of FIGS. 1-8 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. System 10 is usable in any field where automated workflow is desirable or employed. Specifically, the system is used by a HIM to comply with existing regulations regarding completion of patient records. In addition, HIM departments benefit as manual steps within HIM workflows are reduced which reduces potential errors and streamlines processes that formerly required manual intervention by one or more users to complete a process. The processes and applications may in alternative embodiments, be located on one or more (e.g. distributed) processing devices accessing a network linking the elements of FIG. 1. Further, any of the functions and steps provided in FIGS. 1-8 may be implemented in hardware, software or a combination of both and may reside on one or more processing devices located at any location of a network linking the elements of FIG. 1 or another linked network including the Internet.

What is claimed is:

1. A healthcare record processing system for managing encounter record completion, comprising:
a configuration processor enabling association of configurable record completion criteria with a type of encounter of a patient and with a healthcare provider organization and with a subscribing application;
a data processor for determining when a particular patient record of an encounter having a particular type meets associated record completion criteria in response to a predetermined event;
a communication processor for automatically communicating a notification message to said subscribing application, said notification message indicating to said subscribing application, said particular patient record of said encounter is available for processing, and
a task processor for initiating a sequence of tasks to be performed by at least one healthcare worker using said subscribing application in response to a determination said particular patient record of said encounter having said particular type meets said associated completion criteria.

2. A system according to claim 1, wherein
said task processor comprises a workflow processor and releases said particular patient record of said encounter for processing by said subscribing application and inhibits release until said patient record of said encounter meets said associated completion criteria.

3. A system according to claim 1, wherein
said record completion criteria are configurable by said subscribing application and indicate document content required in a record of a type of encounter, for said record to be designated complete.

4. A system according to claim 1, wherein
said task processor comprises a workflow processor and automatically initiates a plurality of workflows individually comprising sequence of tasks to be performed by at least one healthcare worker or device.

5. A system according to claim 4, wherein
said workflow processor automatically initiates a plurality of concurrently operating workflows.

6. A system according to claim 1, wherein
said data processor re-evaluates whether a particular patient record of an encounter meets associated record completion criteria in response to a predetermined event and
said task processor automatically communicates a notification message to said subscribing application in response to a re-evaluation.

7. A system according to claim 1, wherein
in response to a predetermined event, said data processor identifies a subscribing application associated with said event and acquires record completion criteria associated with said subscribing application and
said data processor determines when a particular patient record of an encounter meets acquired record completion criteria associated with said subscribing application.

8. A healthcare record processing system for managing encounter record completion, comprising:
a configuration processor enabling association of configurable record completion criteria with a type of encounter of a patient and with a healthcare provider organization, said record completion criteria being configurable by an executable application and indicating document content required in a record of a type of encounter, for said record to be designated complete;
a data processor for determining when a particular patient record of an encounter having a particular type meets associated completion criteria in response to a predetermined event; and
a workflow processor for automatically initiating a sequence of tasks to be performed by at least one healthcare worker in response to a determination said particular patient record of said encounter having said particular type meets said associated completion criteria.

9. A system according to claim 8, wherein
said record completion criteria is automatically and dynamically configurable by data received from said executable application.

10. A system according to claim 9, wherein
said record completion criteria is automatically and dynamically configurable with criteria having at least one of, (a) a particular start date and (b) a particular start time.

11. A system according to claim 10, wherein
said record completion criteria is automatically and dynamically configurable with criteria having at least one of, (a) a particular stop date and (b) a particular stop time.

12. A system according to claim 8, wherein
said record completion criteria are configurable to be associated with a selected executable application, enabling said record completion criteria to be dynamically customized for a particular executable application.

13. A system according to claim 8, wherein
said record completion criteria are configurable to be associated with a selected plurality of executable applications, enabling said record completion criteria to be dynamically customized for a particular plurality of executable applications.

14. A system according to claim 8, wherein
said record completion criteria are configurable to be associated with at least one user, enabling said record completion criteria to be dynamically customized for said at least one user.

15. A system according to claim 8, wherein
said record completion criteria are configurable by a user.

16. A system according to claim 8, wherein
a type of encounter comprises at least one of, (a) a patient visit to a hospital, (b) an inpatient stay, (c) an outpatient encounter.

17. A system according to claim 8, wherein
said record completion criteria determines at least one of, (a) documents necessary in an encounter record of a particular type, (b) documents needing to be signed in an encounter record of a particular type and (c) information needed to be in a document in an encounter record of a particular type.

18. A system according to claim 8, wherein
said predetermined event comprises at least one of, (a) addition of a document to said particular patient record of said encounter, (b) signing of a document in said particular patient record of said encounter and (c) addition of information to a document in said particular patient record of said encounter.

19. A system according to claim 8, wherein
said record completion criteria indicate minimum document content required in a record of a type of encounter, for said record to be designated complete.

20. A system according to claim 8, wherein
said workflow processor automatically initiates a plurality of workflow processes individually comprising a sequence of tasks to be performed by at least one healthcare worker.

21. A system according to claim 8, wherein
said record completion criteria indicates characteristics of a document required in a record of a type of encounter, for said record to be designated complete.

22. A system according to claim 21, wherein
said characteristics of said document include a Document Type.

23. A system according to claim 22, wherein
said Document Type includes at least one of (a) discharge summary, (b) a face sheet, (c) correspondence, (d) EKG information, (e) a nursing assessment of a patient and (f) a dictated report.

24. A healthcare record processing system for managing encounter record completion, comprising:
a configuration processor enabling association of configurable record completion criteria with a type of encounter of a patient and with a healthcare provider organization and with a subscribing application;
a data processor for, in response to a predetermined event,
identifying a subscribing application associated with said event,
acquiring record completion criteria associated with said subscribing application and
determining when a particular patient record of an encounter having a particular type meets acquired record completion criteria associated with said subscribing application;
a communication processor for automatically communicating a notification message to said subscribing application, said notification message indicating to said subscribing application, said particular patient record of said encounter is available for processing; and
a workflow processor for initiating a sequence of tasks to be performed by at least one healthcare worker using said subscribing application in response to a determination said particular patient record of said encounter having said particular type meets said associated completion criteria.
